(19) United States
(12) Patent Application Publication
(10) Pub. No.: US 2026/0268172 A1
(43) Pub. Date: Sep. 10, 2026

(54) METHOD AND SYSTEM FOR PREDICTING INCIDENTS USING HISTORICAL DATA

(71) Applicant: JPMorgan Chase Bank, N.A., New York, NY (US)

(72) Inventors: Arunkumar SELVARAJ, Bengaluru (IN); Lalit SINGH, Mumbai (IN); Vathsa RAO, Bangalore (IN); Pranjal GUPTA, Mumbai (IN)

(73) Assignee: JPMorgan Chase Bank, N.A., New York, NY (US)

(21) Appl. No.: 19/193,384

(22) Filed: Apr. 29, 2025

(30) Foreign Application Priority Data
Mar. 7, 2025 (IN) 202511020755

(51) Int. Cl. G06N 5/022; G06N 5/04

(52) U.S. Cl. CPC G06N 5/022; G06N 5/04

(57) ABSTRACT

A system and method for predicting incidents using historical data are disclosed. The method includes receiving a plurality of data sets from a plurality of sources. The method also includes analyzing the plurality of data sets to extract a historical incident data from the plurality of data sets in accordance with a predefined criteria. The method includes training a model based on the historical incident data. The method further includes receiving at least one code modification associated with an entity to identify a potential incident. The method further includes estimating, using the trained model, a degree of risk associated with the potential incident for an execution of the at least one code modification. Thereafter, the method includes sending an alert to a user equipment based on the estimated degree of risk for the at least one code modification.

### CROSS-REFERENCE TO RELATED APPLICATIONS

This application claims priority benefit from Indian Application No. 202511020755, filed on Mar. 7, 2025, in the India Patent Office, which is hereby incorporated by reference in its entirety.

### FIELD OF THE DISCLOSURE

This technology generally relates to the field of machine learning based prediction of incidents, and more particularly relates to methods and systems for predicting incidents using historical data.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In many industries such as customer support, tech, transportation, and event management, effective incident management is critical for maintaining operational efficiency and customer satisfaction. In the tech industry, any changes to code that is to be released into production is tracked using a service management platform such as ServiceNow® (SNOW) tickets (e.g., a service now product that contains details about the code change and how that is being released to production). After the code is released to the production environment and due to any error in the code change, the production environment is impacted in a way it is not supposed to be, which results in creation of an incident ticket and tied to the SNOW ticket initially created for the code change.

Traditional approaches to handling incidents involve the use of a ticketing system, where issues or requests are logged, tracked, and resolved. However, these ticketing systems often lack the capability to predict incidents before it happens, leading to unexpected business impact and downtime. The traditional approaches also failed to predict factors that can cause issues and how severe that might be.

Current ticketing solutions typically categorize incidents based on predefined criteria, such as urgency and impact. These methods or solutions provide some structure on manual input and historical averages, which can overlook real-time dynamics as well as untraceable factors and the unique context of each incident. Moreover, these methods or solutions that provide some structure on manual input and historical averages add complexity to the overall system or process, thereby failing to resolve data integration or synchronization or transfer issues among various computer implemented tools having various heterogenous systems running therein and subjecting the overall systems to malicious cyber-attacks due to the manual nature of defining tasks. Some conventional orchestration tools may incorporate process mining techniques which may allow users to infer workflows from examples. However, these conventional techniques require examples, and additionally, the users should check for the correctness of the induced workflows. Thus, today's conventional orchestration tools fail to dynamically and automatically compose workflows or plans and execute them. For example, traditional incident reporting systems failed to identify potential incidents for ongoing processes or code releases into a production environment for various associated entities. Hence impacting the production.

Hence, in light of these and other existing limitations, there arises an imperative need to provide an efficient solution to overcome the above-mentioned limitations and to provide a method and system that can predict the potential incidents before it happens.

### SUMMARY

The present disclosure, through one or more of its various aspects, embodiments, and/or specific features or sub-components, provides, inter alias, various systems, servers, devices, methods, media, programs, and platforms for predicting incidents using historical data.

According to an aspect of the present disclosure, a method for predicting incidents using historical data is disclosed. The method is implemented by at least one processor. The method includes receiving, by the at least one processor, a plurality of data sets from a plurality of sources. The method includes analyzing, by the at least one processor, the plurality of data sets to extract a historical incident data from the plurality of data sets in accordance with a predefined criteria. The method further includes training, by the at least one processor, a model based on the historical incident data. The method further includes receiving, by the at least one processor, at least one code modification associated with an entity to identify a potential incident. The method further includes estimating, by the at least one processor using the trained model, a degree of risk associated with the potential incident for an execution of the at least one code modification. Thereafter, the method includes sending, by the at least one processor, an alert to a user equipment based on the estimated degree of risk for the at least one code modification.

In accordance with an exemplary embodiment, the plurality of data sets may include at least one from among: a change request, an incident record, a deployment data, a workload metric, and a code modification utilized for the incident record.

In accordance with an exemplary embodiment, the historical incident data may comprise at least one from among: a historical incident and a code modification involved in the historical incident.

In accordance with an exemplary embodiment, the predefined criteria may include a weight assigned to each factor from a plurality of factors associated with the plurality of data sets.

In accordance with an exemplary embodiment, estimating the degree of risk may further include categorizing, by the at least one processor, the at least one code modification based on the estimated degree of risk. The method may include determining, by the at least one processor, a probability of an occurrence of the potential incident for the at least one code modification.

In accordance with an exemplary embodiment, the potential incident may include at least one from among: an occurrence of the potential incident based on the execution of the at least one code modification and an absence of the potential incident based on the execution of the at least one code modification.

In accordance with an exemplary embodiment, the plurality of data sets may be received from the plurality of sources using a plurality of data pipelines.

According to another aspect of the present disclosure, a computing device configured to predict incidents using historical data is disclosed. The computing device includes a processor; a memory storing instructions; and a communication interface coupled to each of the processor and the memory. The processor may be programmed to cooperate with the instructions to perform operations including: receive a plurality of data sets from a plurality of sources; analyze the plurality of data sets to extract a historical incident data from the plurality of data sets in accordance with predefined criteria; train a model based on the historical incident data; receive at least one code modification associated with an entity to identify a potential incident; estimate, via the trained model, a degree of risk associated with the potential incident for an execution of the at least one code modification; and send an alert to a user equipment based on the estimated degree of risk for the at least one code modification.

In accordance with an exemplary embodiment, the plurality of data sets may include at least one from among: a change request, an incident record, a deployment data, a workload metric, and a code modification utilized for the incident record.

In accordance with an exemplary embodiment, the historical incident data may comprise at least one from among: a historical incident and a code modification involved in the historical incident.

In accordance with an exemplary embodiment, the predefined criteria may include a weight assigned to each factor from a plurality of factors associated with the plurality of data sets.

In accordance with an exemplary embodiment, to estimate the degree of risk, the processor may be configured to categorize the at least one code modification based on the estimated degree of risk; and may determine a probability of an occurrence of the potential incident for the at least one code modification.

In accordance with an exemplary embodiment, the potential incident may include at least one from among: an occurrence of the potential incident based on the execution of the at least one code modification and an absence of the potential incident based on the execution of the at least one code modification.

In accordance with an exemplary embodiment, the plurality of data sets may be received from the plurality of sources using a plurality of data pipelines.

According to yet another aspect of the present disclosure, a non-transitory computer-readable storage medium storing instructions to predict incidents using historical data is disclosed. The instructions include executable code which, when executed by a processor, may cause the processor to receive a plurality of data sets from a plurality of sources; analyze the plurality of data sets to extract a historical incident data from the plurality of data sets in accordance with predefined criteria; train a model based on the historical incident data; receive at least one code modification associated with an entity to identify a potential incident; estimate, via the trained model, a degree of risk associated with the potential incident for an execution of the at least one code modification; and send an alert to a user equipment based on the estimated degree of risk for the at least one code modification.

In accordance with an exemplary embodiment, the plurality of data sets may include at least one from among: a change request, an incident record, a deployment data, a workload metric, and a code modification utilized for the incident record.

In accordance with an exemplary embodiment, the historical incident data may comprise at least one from among: a historical incident and a code modification involved in the historical incident.

In accordance with an exemplary embodiment, the predefined criteria may include a weight assigned to each factor from a plurality of factors associated with the plurality of data sets.

In accordance with an exemplary embodiment, to estimate the degree of risk, the executable code when executed may cause the processor to categorize the at least one code modification based on the estimated degree of risk; and determine a probability of an occurrence of the potential incident for the at least one code modification.

In accordance with an exemplary embodiment, the potential incident may include at least one from among: an occurrence of the potential incident based on the execution of the at least one code modification and an absence of the potential incident based on the execution of the at least one code modification.

In accordance with an exemplary embodiment, the plurality of data sets may be received from the plurality of sources using a plurality of data pipelines.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for predicting incidents using historical data, in accordance with an exemplary embodiment of the present disclosure.

FIG. 2 illustrates an exemplary diagram of a network environment for predicting incidents using historical data, in accordance with an exemplary embodiment of the present disclosure.

FIG. 3 illustrates a system diagram for predicting incidents using historical data, in accordance with an exemplary embodiment of the present disclosure.

FIG. 4 illustrates an exemplary method flow diagram for predicting incidents using historical data, in accordance with an exemplary embodiment of the present disclosure.

FIG. 5 illustrates a block diagram representing a system for predicting incidents using historical data, in accordance with an exemplary embodiment of the present disclosure.

### DETAILED DESCRIPTION

Exemplary embodiments will now be described with reference to the accompanying drawings. The invention may, however, be embodied in many different forms and should not be construed as limited to the embodiments set forth herein, rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it may be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Existing systems or solutions fail to identify potential incidents that may occur after code releases or code modifications are applied to systems or applications. Additionally, the existing solutions are unable to predict incidents for such code releases or code modifications which may hamper a production environment of an organization and lead to delays in services related to various systems or applications. Moreover, as mentioned earlier, these existing systems or solutions that provide some structure on manual input and historical averages add complexity to the overall system or process, thereby failing to resolve data integration or synchronization or transfer issues among various computer implemented tools having various heterogenous systems running therein and subjecting the overall systems to malicious cyber-attacks due to the manual nature of defining tasks. Some conventional orchestration tools may incorporate process mining techniques which may allow users to infer workflows from examples. However, these conventional techniques require examples, and additionally, the users should check for the correctness of the induced workflows. Thus, today's conventional orchestration tools fail to dynamically and automatically compose workflows or plans and execute them. For example, traditional incident reporting systems failed to identify potential incidents for ongoing processes or code releases into a production environment for various associated entities. Hence impacting the production.

To overcome the above-mentioned problems, the present disclosure provides a method and a system for predicting incidents using historical data. In the present disclosure, at first the system receives a plurality of data sets from a plurality of sources. Further, the system analyzes the plurality of data sets to extract a historical incident data from the plurality of data sets in accordance with predefined criteria. The system further trains a model based on the historical incident data. The system further receives at least one code modification associated with an entity to identify a potential incident. The system further estimates, via the trained model, a degree of risk associated with the potential incident for an execution of the at least one code modification. Thereafter, the system sends an alert to a user equipment based on the estimated degree of risk for the at least one code modification.

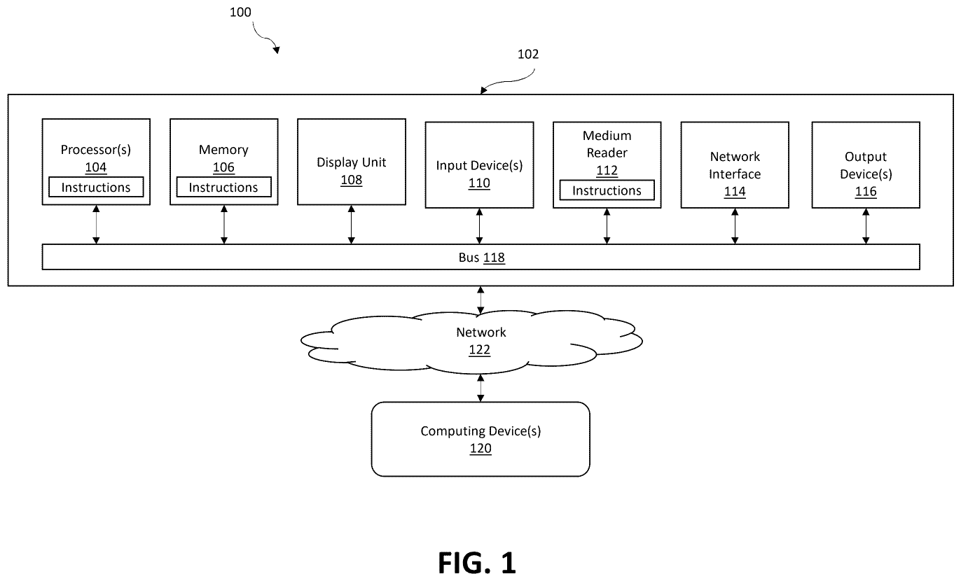

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms may be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations may include distributed processing, component/object distributed processing, and parallel processing. Virtual computer system processing may be constructed to implement one or more of the methods or functionalities as described herein, and a processor 104 described herein may be used to support a virtual processing environment.

As described herein, various embodiments provide methods and systems for predicting incidents using historical data.

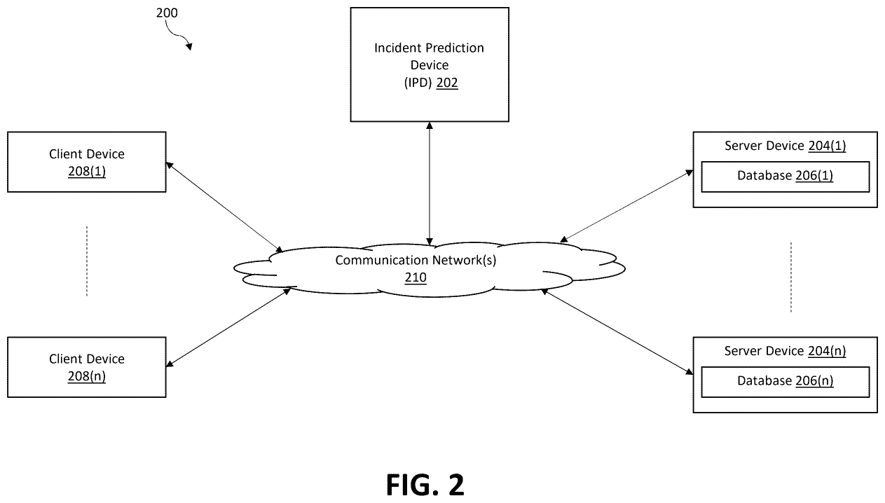

Referring to FIG. 2, a schematic of an exemplary network environment 200 for predicting incidents using historical data is illustrated. In an exemplary implementation, the method is executable on any networked computer platform, such as, for example, a personal computer (PC).

The method for predicting incidents using historical data may be executed by an incident prediction device (IPD) 202. The IPD 202 may be the same or similar to the computer system 102 as described with respect to FIG. 1. The IPD 202 may store one or more applications that may include executable instructions that, when executed by the IPD 202, cause the IPD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the IPD 202 itself, may be located in the virtual server(s) running in a cloud-based computing environment rather than being tied to one or more specific physical network computing devices. Also, the application(s) may be running in one or more virtual machines (VMs) executing on the IPD 202. Additionally, in one or more embodiments of this technology, virtual machine(s) running on the IPD 202 may be managed or supervised by a hypervisor.

In the network environment 200 of FIG. 2, the IPD 202 is coupled to a plurality of server devices 204(1)-204(n) that host a plurality of databases 206(1)-206(n), and also to a plurality of client devices 208(1)-208(n) via communication network(s) 210. A communication interface of the IPD 202, such as the network interface 114 of the computer system 102 of FIG. 1, operatively couples and communicates between the IPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and IPDs that efficiently implement the method for predicting incidents using historical data.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The IPD 202 may be a standalone device or integrated with one or more other devices or apparatuses, such as one or more of the server devices 204(1)-204(n), for example. In one particular example, the IPD 202 may include or be hosted by one of the server devices 204(1)-204(n), and other arrangements are also possible. Moreover, one or more of the devices of the IPD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the IPD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store historical incident data, deployment data, change requests, for implementation of the features of the present disclosure.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the IPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the IPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the IPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IPD 202, the server devices 204(1)-204(n), or the client devices 208(1)-208(n), for example, may be configured to operate as virtual instances on the same physical machine. In other words, one or more of the IPD 202, the server devices 204(1)-204(n), or the client devices 208(1)-208(n) may operate on the same physical device rather than as separate devices communicating through communication network(s) 210. Additionally, there may be more or fewer IPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

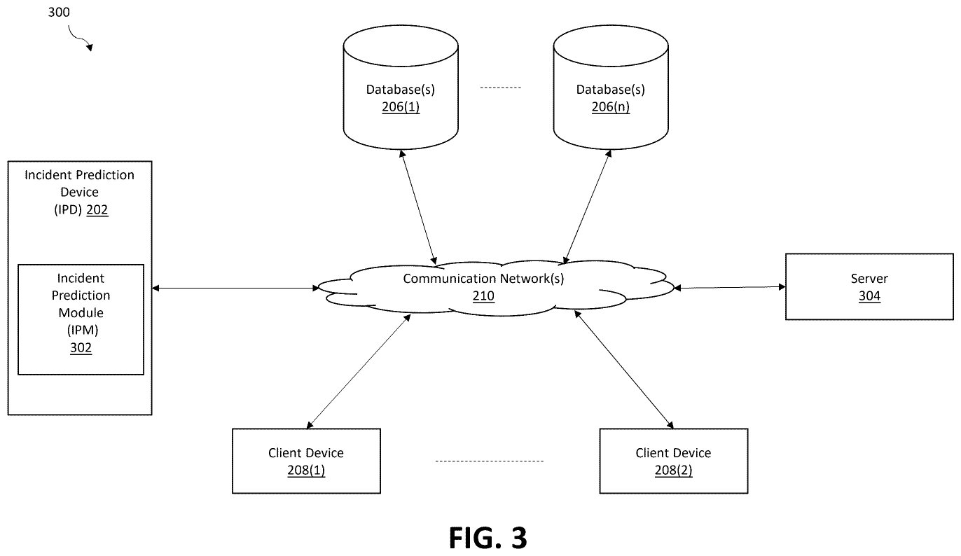

FIG. 3 illustrates a system diagram for predicting incidents using historical data, in accordance with an exemplary embodiment.

As illustrated in FIG. 3, the system 300 may include an incident prediction device (IPD) 202 within which an incident prediction module (IPM) 302 is embedded, a server 304, a database(s) 206(1) . . . 206(n), a plurality of client devices 208(1) . . . 208(2), and a communication network(s) 210.

According to exemplary embodiments, the system 300 may comprise the IPD 202 including the IPM 302 may be connected to the server 304 and the database(s) 206(1) . . . 206(n) via the communication network(s) 210, but the disclosure is not limited thereto. The IPD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the IPD 202 is described and shown in FIG. 3 includes the IPM 302, although it may include other rules, policies, modules, databases, or applications, for example. As will be described below, the IPM 302 is configured to carry out a method for predicting incidents using historical data.

An exemplary system 300 for enabling a mechanism to predict incidents using historical data by utilizing the network environment of FIG. 2 is shown as being executed in FIG. 3. Specifically, a first client device 208(1) and a second client device 208(2) are illustrated as being in communication with the IPD 202. In this regard, the first client device 208(1) and the second client device 208(2) may be “clients” of the IPD 202 and are described herein as such. Nevertheless, it is to be known and understood that the first client device 208(1) and/or the second client device 208(2) need not necessarily be “clients” of the IPD 202, or any entity described in association therewith herein. Any additional or alternative relationship may exist between either or both of the first client device 208(1) and the second client device 208(2) and the IPD 202, or no relationship may exist.

Further, the IPD 202 is illustrated as being able to access one or more database(s) 206(1) . . . 206(n). The IPM 302 may be configured to access these repositories/databases to provide a method for predicting incidents using historical data. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the IPD 202 via broadband or cellular communication. These embodiments are merely exemplary and are not limiting or exhaustive.

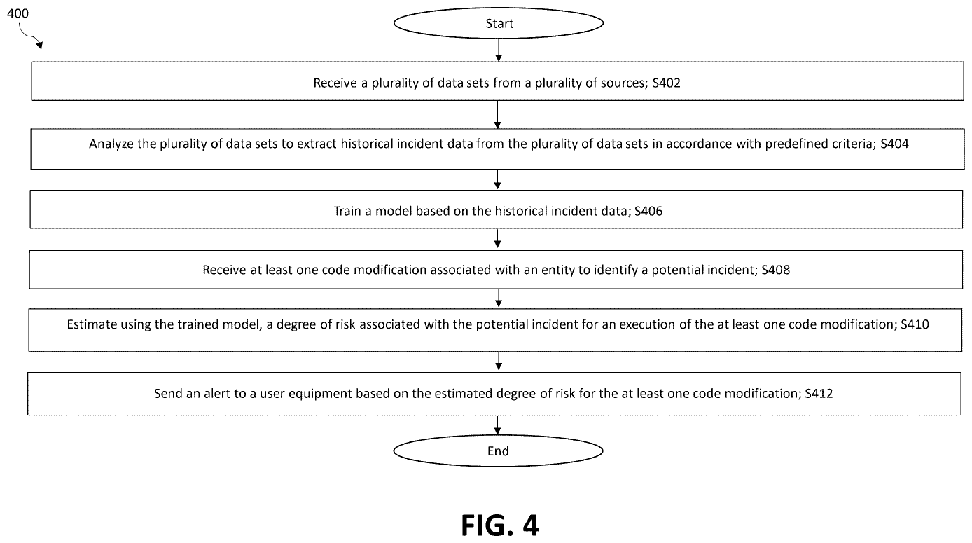

Referring to FIG. 4, an exemplary method 400 is shown for predicting incidents using historical data, in accordance with an exemplary implementation.

The method begins when an entity seeks prediction of potential incidents for any code modifications or changes released in a production environment. The method 400 is implemented by at least one processor 104. As used herein, entity refers to an individual (e.g., a developer) or a system which performs code modifications and code releases within a production environment of an organization.

At step S402, the method includes receiving, by the at least one processor 104, a plurality of data sets from a plurality of sources. In an embodiment, the plurality of data sets may include at least one from among: a change request, an incident record, a deployment data, a workload metric, and a code modification utilized for the incident record. For example, the plurality of data sets may be collected from the plurality of sources such as a code build tool (e.g., JET™), an issue progress tracking and maintenance tool (e.g., JIRA™), a code repository hosting service (e.g., Bitbucket®) and an incident management platform (e.g., SNOW™). The weightage that is given to each of these sources is decided automatically by the system.

The change request may refer to a change ticket that documents a proposed change to an application or infrastructure related to a production environment. The change request may include details such as a change type, description, an impact assessment, and approval status. Incident records may include incident tickets. The code modifications utilized for the incident records refer to the changes or enhancements made to a software code for any new ticket or file in a production environment. For example, if a code change causes an unexpected behavior in the production environment, an incident ticket is created and attached to the change ticket that is associated with the change request that caused the code change.

The plurality of sources may include an issue tracing platform, a ticket management platform, and a development platform. In an exemplary implementation, the at least one processor 104 may perform a data filtering process on the received plurality of data sets. The data filtering may include identification and elimination of any duplicate entries from the plurality of data sets. In an exemplary implementation, the plurality of data sets may be received from the plurality of sources using a plurality of data pipelines.

In some embodiments, the plurality of data pipelines may include a cloud-native data integration and transformation pipeline to eliminate the complexity typically associated with traditional extract, transform, and load (ETL) tools. For example, the plurality of pipelines may handle both simple and complex transformations while maintaining enterprise-grade security and governance, thereby guaranteeing zero data loss, maintaining clear lineage tracking, scaling both computing power and pipeline complexity, providing real-time monitoring and alerting for pipeline health, detailed logs, and automated alerts that help solve problems fast, implementing end-to-end encryption, granular access controls, and complete audit trails that satisfy compliance requirements, dynamic pipeline generation based on business logic, built-in versioning and testing frameworks, hybrid data integration capabilities, serverless data ingestion, automated documentation generation, etc., but the disclosure is not limited thereto.

At step S404, the method includes analyzing, by the at least one processor 104, the plurality of data sets to extract a historical incident data from the plurality of data sets in accordance with a predefined criteria.

In an embodiment, the historical incident data may include historical incidents and the code modifications involved in the historical incidents. In an exemplary implementation, the predefined criteria may include a weight assigned to each factor from a plurality of factors (e.g., columns of the dataset) associated with the plurality of data sets. The predefined criteria may include various factors that have caused incidents in the past. In an exemplary implementation, these factors may include trackable code changes and may also include some untraceable factors. Each of these factors is assigned a weight which indicates a bias in training a model. The historical incidents may refer to past events or occurrences that have been documented and recorded within an organization's incident management system. The historical incidents may include data related to system outages, security breaches, service disruptions, and any significant operational challenges. The code modifications involved in the historical incidents are the changes made to software or systems in response to the historical incidents.

The code modifications are typically made to fix bugs, resolve vulnerabilities, or enhance system performance. After an incident (such as a security breach, service disruption, or system outage), the software is updated to correct or prevent the issues that caused the incident. The code modifications may include security patches, feature adjustments, code changes or configuration changes (e.g., database settings or server settings).

At step S406, the method includes training, by the at least one processor 104, a model based on the historical incident data. The historical incident data may include at least one from among: the historical incident and a code modification involved in the historical incident.

In an exemplary implementation, the model may be a machine learning (ML) model. The ML model may be configured using machine learning algorithms. The historical incident data may be stored in a database for continuous learning and training of the ML model.

At step S408, the method includes receiving, by the at least one processor 104, at least one code modification associated with an entity to identify a potential incident.

As used herein, entity refers to an individual (e.g., a developer) or a system which performs the code modifications and code releases within a production environment of an organization. The code modifications refer to a specific change or enhancement made to the software code of an application or system. The potential incident may include at least one from among the occurrence of the potential incident based on the execution of the at least one code modification and an absence of the potential incident based on the execution of the at least one code modification.

For example, if a software application has been experiencing performance issues during peak usage times, leading to system slowdowns and user complaints, then an entity may implement at least one code modification (e.g., caching mechanism) to improve data retrieval speed. So, the at least one processor 104 using the trained model receives the at least one code modification (e.g., caching mechanism) for predicting occurrence of the potential incident.

At step S410, the method includes estimating, by the at least one processor 104 using the trained model, a degree of risk associated with the potential incident for an execution of the at least one code modification.

In an exemplary implementation, estimating the degree of risk may further include categorizing, by the at least one processor 104, the at least one code modification based on the estimated degree of risk. The method may further include determining, by the at least one processor 104, a probability of an occurrence of the potential incident for the at least one code modification. The estimated degree of risks may include risk categories, but not limited to, such as a low risk, a medium risk, a high risk, and a critical risk. The potential incident may include at least one from among: an occurrence of the potential incident based on the execution of the at least one code modification and an absence of the potential incident based on the execution of the at least one code modification.

For example, suppose for a modification in a code block A, the at least one processor 104 using the trained model, estimates greater than 60 percent as a degree of risk, then the modification of the code block A is categorized as high risk code modification that can cause an incident. If the at least one processor 104 using the trained model estimates a range of 40-60 percent as a degree of risk, then the modification of the code block A is categorized as moderate risk code modification that can cause an incident.

At step S412, the method includes sending, by the at least one processor 104, an alert to a user equipment based on the estimated degree of risk for the at least one code modification.

The alert may include notifications related to potential incidents and details about some historical incidents caused by similar code modifications. The user equipment is associated with the entity. The user equipment may include, but is not limited to, a smartphone, a tablet, a laptop, and a computer. The user equipment may render the alert on a user interface (UI). The UI may be a graphical user interface (GUI). It will be appreciated by the person skilled in the art that by sending the alert to the user equipment, the disclosed method flags potential incidents to the user for code modifications which helps in preemptive identification of incidents and avoids possible incidents in a production.

This way the method disclosed in the present disclosure predicts incidents using historical incident data.

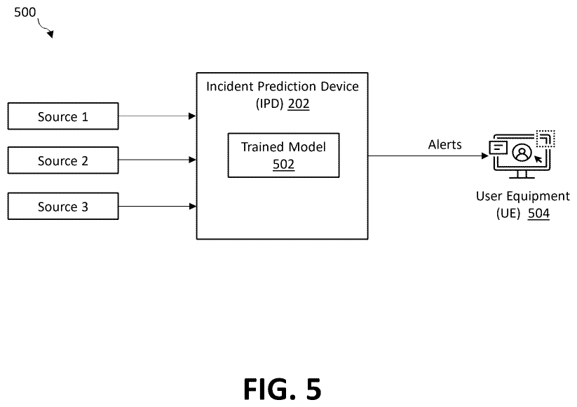

FIG. 5, illustrating a block diagram that represents a system for predicting incidents using historical data, in accordance with an exemplary embodiment. As illustrated in FIG. 5, the process flow 500 begins with receiving, by an incident prediction device (IPD) 202, a plurality of data sets from a plurality of sources (e.g., source 1: an issue tracing platform, source 2: a ticket management platform, and source 3: a development platform). For example, the plurality of data sets are collected from the plurality of sources such as a code build tool (e.g., JET™), an issue progress tracking and maintenance tool (e.g., JIRA™), a code repository hosting service (e.g., Bitbucket®) and an incident management platform (e.g., SNOW™). The weightage that is given to each of these sources is decided automatically by the system.

The plurality of data sets may include at least one from among a change request, an incident record, a deployment data, a workload metric, and a code modification utilized for the incident record. In an exemplary implementation, the at least one processor 104 may perform a data filtering process on the received plurality of data sets. The data filtering may include identification and elimination of any duplicate entries from the plurality of data sets.

In an exemplary implementation, the IPD 202 includes a trained model 502 (also referred to as a model 502). The IPD 202 is configured to analyze the plurality of data sets to extract historical incident data from the plurality of data sets in accordance with predefined criteria. The historical incident data may include one from among: a historical incident and a code modification involved in the historical incident.

In an exemplary implementation, the model 502 is trained based on the historical incident data. In an implementation, the model 502 is a machine learning (ML) model and the ML model may be configured using machine learning algorithms. The historical incident data may be stored in a database for continuous learning and training of the ML model. For example, the model 502 is trained on the data of a firm and fine-tuned according to changes made in an application (e.g., code level changes) and incident history, which is able to predict a potential production incident before it happens.

Further, the at least one processor 104, using the trained model 502, estimates a degree of risk associated with a potential incident for execution of at least one code modification associated with an entity, wherein to estimate the degree of risk, the at least one processor 104 is further configured to categorize the at least one code modification based on the estimated degree of risk. The potential incident may include at least one from among an occurrence of the potential incident based on the execution of the at least one code modification and an absence of the potential incident based on the execution of the at least one code modification. The at least one processor 104 is configured to determine a probability of an occurrence of the potential incident for the at least one code modification.

Thereafter, the at least one processor 104 sends an alert to a user equipment 504 based on the estimated degree of risk for the at least one code modification. The user equipment 504 is associated with the entity.

In an embodiment, the user equipment 504 may include but is not limited to, a smartphone, a tablet, a laptop, and a computer. It is to be noted that by sending alerts to the user equipment 504, the disclosed system flags potential incidents to the user which helps in preemptive identification of issues and avoids possible incidents in a production. This way the system disclosed in the present disclosure predicts incidents using historical incident data.

It will be appreciated by the person skilled in the art that the system offers a full-circle, adaptable, and intelligent solution for implementing a system to predict incidents using historical data.

The present disclosure provides numerous advantages as given below. The disclosed method identifies risk based on historical changes and risks that cause potential incidents. The disclosed method helps in avoiding production delays based on preemptive identification of incidents for code modifications that are being checked in a production environment. The disclosed method thus helps in avoiding business impact. The disclosed method further helps in identifying potential issues before they escalate, helps teams to address vulnerabilities early, and helps in reducing the likelihood of critical failures. By predicting incidents, teams can implement preventive measures, leading to more stable software and fewer disruptions during and after releases. Early detection of possible incidents can minimize system downtime, which is crucial for maintaining user satisfaction and trust.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tape, or other storage device to capture carrier wave signals such as a signal communicated via a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to predict incidents using historical data is disclosed. The instructions include executable code which, when executed by a processor 104, may cause the processor 104 to receive a plurality of data sets from a plurality of sources; analyze the plurality of data sets to extract historical incident data from the plurality of data sets in accordance with predefined criteria; train a model based on the historical incident data; receive at least one code modification associated with an entity to identify a potential incident; estimate, via the trained model, a degree of risk associated with the potential incident for an execution of the at least one code modification ; and sends an alert to a user equipment based on the estimated degree of risk for the at least one code modification.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those skilled in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for predicting incidents using historical data, the method being implemented by at least one processor, the method comprising:
receiving, by the at least one processor, a plurality of data sets from a plurality of sources;
analyzing, by the at least one processor, the plurality of data sets to extract a historical incident data from the plurality of data sets in accordance with a predefined criteria;
training, by the at least one processor, a model based on the historical
incident data;
receiving, by the at least one processor, at least one code modification associated with an entity to identify a potential incident;
estimating, by the at least one processor using the trained model, a degree of risk associated with the potential incident for an execution of the at least one code modification; and
sending, by the at least one processor, an alert to a user equipment based on the estimated degree of risk for the at least one code modification.

2. The method as claimed in claim 1, wherein the plurality of data sets comprises at least one from among: a change request, an incident record, a deployment data, a workload metric, and a code modification utilized for the incident record.

3. The method as claimed in claim 1, wherein the historical incident data comprises at least one from among a historical incident and a code modification involved in the historical incident.

4. The method as claimed in claim 1, wherein the predefined criteria comprises a weight assigned to each factor from a plurality of factors associated with the plurality of data sets.

5. The method as claimed in claim 1, wherein estimating the degree of risk further comprises:
categorizing, by the at least one processor, the at least one code modification
based on the estimated degree of risk; and
determining, by the at least one processor, a probability of an occurrence of the potential incident for the at least one code modification.

6. The method as claimed in claim 1, wherein the potential incident comprises at least one from among: an occurrence of the potential incident based on the execution of the at least one code modification, and an absence of the potential incident based on the execution of the at least one code modification.

7. The method as claimed in claim 1, wherein the plurality of data sets are received from the plurality of sources using a plurality of data pipelines.

8. A computing device configured for predicting incidents using historical data, the computing device comprising:
a processor;
a memory storing instructions; and
a communication interface coupled to each of the processor and the memory, wherein the processor is programmed to cooperate with the instructions to perform operations comprising:
receive a plurality of data sets from a plurality of sources;
analyze the plurality of data sets to extract a historical incident data from the plurality of data sets in accordance with a predefined criteria;
train a model based on the historical incident data;
receive at least one code modification associated with an entity to identify a potential incident;
estimate, via the trained model, a degree of risk associated with the potential incident for an execution of the at least one code modification; and
send an alert to a user equipment based on the estimated degree of risk for the at least one code modification.

9. The computing device as claimed in claim 8, the plurality of data sets comprises at least one from among change requests, incident records, deployment data, workload metrics, and code modifications utilized for the incident records.

10. The computing device as claimed in claim 8, wherein the historical incident data comprises at least one from among: a historical incident and a code modification involved in the historical incident.

11. The computing device as claimed in claim 8, wherein the predefined criteria comprises a weight assigned to each factor from a plurality of factors associated with the plurality of data sets.

12. The computing device as claimed in claim 8, wherein to estimate the degree of risk, the processor is further configured to:
categorize the at least one code modification based on the estimated degree of risk; and
determine a probability of an occurrence of the potential incident for the at least one code modification.

13. The computing device as claimed in claim 8, wherein the potential incident comprises at least one from among: an occurrence of the potential incident based on the execution of the at least one code modification, and an absence of the potential incident based on the execution of the at least one code modification.

14. The computing device as claimed in claim 8, wherein the plurality of data sets are received from the plurality of sources using a plurality of data pipelines.

15. A non-transitory computer readable storage medium storing instruction for predicting incidents using historical data, the instructions comprising executable code which when executed by a processor, causes the processor to perform operations comprising:
receive a plurality of data sets from a plurality of sources;
analyze the plurality of data sets to extract a historical incident data from the plurality of data sets in accordance with a predefined criteria;
train a model based on the historical incident data;
receive at least one code modification associated with an entity to identify a potential incident;
estimate, via the trained model, a degree of risk associated with the potential incident for an execution of the at least one code modification; and
send an alert to a user equipment based on the estimated degree of risk for the at least one code modification.

16. The non-transitory computer readable storage medium as claimed in claim 15, wherein the plurality of data sets comprises at least one from among a change request, an incident record, a deployment data, a workload metric, and a code modification utilized for the incident record.

17. The non-transitory computer readable storage medium as claimed in claim 15, the historical incident data comprises at least one from among: a historical incident and a code modification involved in the historical incident.

18. The non-transitory computer readable storage medium as claimed in claim 15, wherein the predefined criteria comprises a weight assigned to each factor from a plurality of factors associated with the plurality of data sets.

19. The non-transitory computer readable storage medium as claimed in claimed 15, wherein estimating the degree of risk further comprises:
categorizing, by the at least one processor, the at least one code modification based on the estimated degree of risk; and
determining, by the at least one processor, a probability of an occurrence of the potential incident for the at least one code modification.

20. The non-transitory computer readable storage medium as claimed in claim 15, wherein the potential incident comprises at least one from among: an occurrence of the potential incident based on the execution of the at least one code modification, and an absence of the potential incident based on the execution of the at least one code modification.
